(19) United States
(12) Patent Application Publication
(10) Pub. No.: US 2010/0221654 A1
(43) Pub. Date: Sep. 2, 2010

(54) Pigment Preparations Based on C.I. Pigment Blue 15,6

(75) Inventors: Jens Reichwagen, Wiesbaden (DE); Carsten Plueg, Muehltal/Niederbeerbach (DE); Thomas Metz, Heppenheim (DE)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT FINANCE (BVI) LIMITED, Tortola (VG)

(21) Appl. No.: 12/669,424

(22) PCT Filed: Jun. 17, 2008
(86) PCT No.: PCT/EP08/04854

§ 371 Date: Jan. 15, 2010

(30) Foreign Application Priority Data
Jul. 17, 2007 (DE) 10 2007 033 192.6
Feb. 15, 2008 (DE) 10 2008 009 194.4

(51) Int. Cl. G03G 9/09; C09B 67/50; C09D 11/00; C09D 11/02; C08K 5/3417

(52) U.S. Cl. 430/108.21; 106/411; 106/31.6; 524/88

(57) ABSTRACT

The invention relates to novel fine-particle pigment preparations comprising fine-particle C.I. Pigment Blue 15:6 as a base pigment and pigment dispersants of formula (II) wherein CPC is a radical of a copper phthalocyanine, n is a number between 0.1 and 4, preferably between 0.2 and 2; m is number between 0.1 and 4, preferably 0.2 and 2; Kat is a cation from the group of alkali metals or H⁺; o is a number between 0 and 3.9, preferably between 0 and 1.8; and n=m+o; and R¹, R², R³, R⁴ independently represent hydrogen or a radical from the group comprising C₁-C₂₀ alkyl, C₂-C₂₀alkenyl, C₅-C₂₀cycloalkyl, C₅-C₂₀cycloalkenyl, C₁-C₄ alkylphenyl, the previously cited radicals being optionally branched and optionally substituted by sulf-, carboxy, hydroxy and halogen, with the proviso that one, two or three of the radicals R¹ to R⁴ is/are hydrogen. The invention also relates to the method for producing said pigment preparations.

The present invention relates to novel finely divided pigment preparations comprising C.I. Pigment Blue 15:6 as base pigment and certain pigment dispersants and also to their use especially for color filters.

Copper phthalocyanine pigments for color filter applications often have a very high viscosity and a poor viscosity stability. Moreover, the finely divided pigments greatly tend to agglomerate and aggregate, which has a particularly disadvantageous effect on transparency, color strength and particularly the contrast ratio of the color filters produced with these pigments. The contrast ratio (CR) is measured by determining the light intensity after irradiation through a pigmented coating layer on a transparent substrate placed between two polarizers. The contrast ratio is the ratio of the light intensities for parallel and perpendicular polarizers.

$$C R = \frac{Light intensity ( parallel )}{Light intensity ( perpendicular )}$$

EP-A 0 638 615 describes the salt kneading of crude copper phthalocyanines in the presence of copper phthalocyaninesulfonic acid ammonium salts for use in printing inks. One disadvantage of this process is the conversion of nonstabilized crude copper phthalocyanines into the unwanted beta phase in the operation of salt kneading.

JP 2005-234009 describes pigment preparations comprising sulfonamides, phthalimidomethyl derivatives and sulfonic acids of copper phthalocyanines as well as epsilon-copper phthalocyanines. Here the use of more than one synergist has a disadvantageous effect on the hue of the epsilon-copper phthalocyanine pigment preparation, since the synergists generally have a more greenish hue than the epsilon-copper phthalocyanine.

WO 02/48268 and WO 02/48269 describe pigment preparations comprising organic pigments and sulfonated pigment dispersants laked with calcium ions and/or with quaternary ammonium ions. However, the preparations described do not meet the necessary high standards expected of contrast ratio and brilliance.

It is an object of the present invention to provide pigment preparations comprising C.I. Pigment Blue 15:6 as base pigment which display a clean hue, high brilliance, low viscosity and high contrast ratios in color filter applications.

We have found that this object is achieved by pigment preparations based on C.I. Pigment Blue 15:6 and the hereinbelow-defined pigment dispersants.

The present invention accordingly provides pigment preparations comprising C.I. Pigment Blue 15:6 having a median particle size d₅₀ of 10 to 100 nm and at least one pigment dispersant of the formula (II)

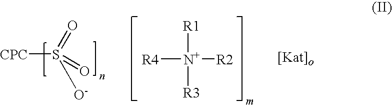

where
CPC is a residue of a copper phthalocyanine,
n is from 0.1 to 4, preferably 0.2 to 2,
m is from 0.1 to 4, preferably 0.2 to 2,
Kat is a cation selected from the group of alkali metals or H⁺;
o is from 0 to 3.9, preferably from 0 to 1.8, subject to n=m+o;
R¹, R², R³, R⁴ are independently hydrogen or a radical selected from the group consisting of C₁-C₂₀-alkyl, C₂-C₂₀-alkenyl, C₅-C₂₀-cycloalkyl, C₅-C₂₀-cycloalkenyl and C₁-C₄-alkylphenyl, which are each optionally branched and optionally substituted by sulfo, carboxyl, hydroxyl and halogen,
with the proviso that one, two or three of R¹ to R⁴ are hydrogen.

Preference is given to pigment preparations wherein CPC is a residue of formula (I)

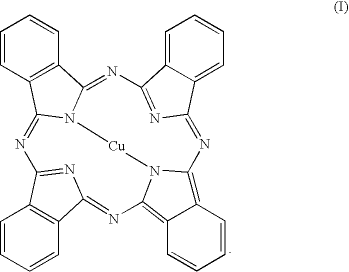

Preference is further given to pigment preparations wherein
R¹, R² and R³ are each hydrogen,
R⁴ is a radical selected from the group consisting of C₁-C₂₀-alkyl,
C₂-C₂₀-alkenyl, C₅-C₂₀-cycloalkyl, C_{5—}C₂₀-cycloalkenyl, C₁-C₄-alkyl-phenyl, which are each optionally branched and optionally substituted by sulfo, carboxyl, hydroxyl and halogen,
m is from 0.1 to 4, preferably 0.2 to 2,
Kat is a cation selected from the group consisting of H⁺, Li⁺, Na⁺ and K⁺
n is from 0.1 to 4, preferably 0.2 to 2, and
o is from 0 to 3.9, preferably from 0 to 1.8.

The radicals R¹, R², R³ and R⁴ are each preferably C₆-C₂₀-alkyl, C₆-C₂₀-alkenyl and benzyl, with the proviso that one, two or three, especially three, of R¹ to R⁴ are hydrogen.

Examples of particularly preferred ammonium radicals NR1R2R3R4⁺ are primary ammonium radicals, such as n-hexyl-, octyl-, nonyl-, decyl-, undecyl-, dodecyl-, tridecyl-, tetradecyl-, pentadecyl-, hexadecyl-, heptadecyl-, octadecyl-, nonadecyl-, eicosyl-ammonium, their monounsaturated radicals, benzyl-, 2-phenylethyl-ammonium; secondary ammonium radicals, such as dibutyl-, dihexyl-, dioctyl-, didecyl-, dioleyl-, distearyl-, dibenzyl-ammonium; tertiary ammonium radicals, such as dimethyloctyl-, dimethyldecyl-, dimethyllauryl-, dimethylstearyl-, trioctyl-, tribenzyl-, bis(2-hydroxyethyl)dodecyl-ammonium.

The weight ratio of C.I. Pigment Blue 15:6 to pigment dispersant of formula (II) in the pigment preparations of the present invention is preferably between 97:3 and 70:30 and more preferably between 95:5 and 80:20.

The base pigment is present in the pigment preparations of the present invention with a median particle size d₅₀ of 10 to 100 nm, preferably 20 to 50 nm. The particle size distribution of C.I. Pigment Blue 15:6 preferably approximates a Gaussian distribution. Thus, the ratio of d₉₅/d₅₀ is preferably less than 4.0:1 and more preferably less than 3.0:1. The primary particles of the base pigment should have a length-to-width ratio of preferably less than 3.0:1 and more preferably less than 2.0:1.

The pigment preparation of the present invention may further comprise 0.5% to 15% by weight, preferably 1% to 10% by weight and especially 2% to 5% by weight of an additive of formula (3), all based on the weight of C.I. Pigment Blue 15:6,

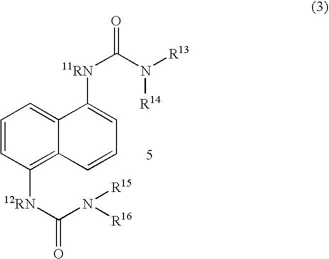

where

R¹¹, R¹², R¹³, R¹⁴, R¹⁵ and R¹⁶ are independently hydrogen; C₁-C₂₂ alkyl or C₂-C₂₂ alkenyl whose carbon chain may in each case be interrupted by one or more groupings —O—, —S—, —NR⁹—, —CO— or SO₂— and/or substituted one or more times by hydroxyl, halogen, aryl, heteroaryl, C₁-C₄ alkoxy and/or acetyl;

C₃-C₈-cycloalkyl whose carbon scaffold may be interrupted by one or more groupings —O—, —S—, —NR¹⁰—, —CO— or SO₂— and/or substituted one or more times by hydroxyl, halogen, aryl, heteroaryl, C₁-C₄-alkoxy and/or acetyl; dehydroabietyl or aryl or heteroaryl, where

R⁹ and R¹⁰ are independently hydrogen or C₁-C₂₂-alkyl, or where R¹³, R¹⁴, R¹⁵ and R¹⁶ are a polyoxyalkylene chain with or without terminal alkylation.

Aryl is preferably C₆-C₁₀-aryl, in particular phenyl or naphthyl. Hetaryl is preferably a five- or six-membered heteroaromatic ring, which is optionally benzofused, containing 1, 2, 3 or 4 heteroatoms selected from the group consisting of N, O and S. R¹¹, R¹², R¹⁴ and R¹⁶ are each preferably hydrogen.

R¹³ and R¹⁵ are each preferably (C₂-C₄-alkylene)-O—(C₁-C₁₆-alkyl).

A preferred additive for the purposes of the present invention is a compound of the general formula (4)

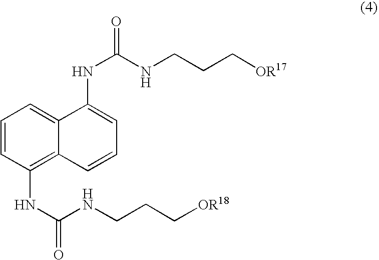

where

R¹⁷ and R¹⁸ are independently hydrogen; C₁-C₁₉ alkyl or C₂-C₁₉ alkenyl whose carbon chain may in each case be interrupted by one or more of the groupings —O—, —S—, —NR⁹—, —CO— or SO₂— and/or substituted one or more times by hydroxyl, halogen, C₁-C₄ alkoxy and/or acetyl, or a radical of the formula -(AO)ₙ—Z, where A is ethylene or propylene, Z is hydrogen or C₁-C₁₆-alkyl, and n is from 1 to 200, preferably 10 to 100;

C₃-C₈-cycloalkyl whose carbon scaffold may be interrupted by one or more groupings —O—, —S—, —CO— or SO₂— and/or substituted one or more times by hydroxyl, halogen, C₁-C₄-alkoxy and/or acetyl; where

R⁹ and R¹⁰ are independently hydrogen or C₁-C₂₂-alkyl.

Particular preference for the purposes of the present invention is given to the additive of formula (5)

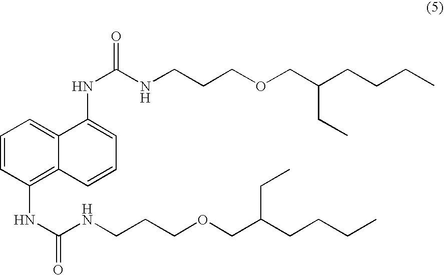

Additives of formula (3), (4) and (5) are obtainable in a conventional manner by reaction of naphthyl diisocyanate with the corresponding amines.

The pigment preparations of the present invention, as well as the phthalocyanine pigment and the pigment dispersant, may further comprise further customary auxiliaries or adjuncts, for example surfactants, dispersants, fillers, standardizers, resins, waxes, defoamers, antidusters, extenders, antistats, preservatives, dryness retardants, wetters, antioxidants, UV absorbers and photostabilizers, preferably in an amount of 0.1% to 10% by weight, in particular 0.5% to 5% by weight, based on the total weight of the pigment preparation.

Useful surfactants include anionic or anion-active, cationic or cation-active and nonionic or amphoteric substances or mixtures thereof.

Useful anion-active substances include for example fatty acid taurides, fatty acid N-methyltaurides, fatty acid isethionates, alkylphenylsulfonates, for example dodecylbenzenesulfonic acid, alkylnaphthalenesulfonates, alkylphenol polyglycol ether sulfates, fatty alcohol polyglycol ether sulfates, fatty acid amide polyglycol ether sulfates, alkyl sulfosuccinamates, alkenylsuccinic monoesters, fatty alcohol polyglycol ether sulfosuccinates, alkanesulfonates, fatty acid glutamates, alkyl sulfosuccinates, fatty acid sarcosides; fatty acids, for example palmitic acid, stearic acid and oleic acid; the salts of these anionic substances and soaps, for example alkali metal salts of fatty acids, naphthenic acids and resin acids, for example abietic acid, alkali-soluble resins, for example rosin-modified maleate resins and condensation products based on cyanuric chloride, taurine, N,N′-diethylaminopropylamine and p-phenylenediamine. Preference is given to resin soaps, i.e., alkali metal salts of resin acids.

Useful cation-active substances include for example quaternary ammonium salts, fatty amine oxalkylates, polyoxyalkyleneamines, oxalkylated polyamines, fatty amine polyglycol ethers, primary, secondary or tertiary amines, for example alkyl-, cycloalkyl or cyclized alkylamines, in particular fatty amines, di- and polyamines derived from fatty amines or fatty alcohols and oxalkylates of the di- and polyamines, fatty acid derived imidazolines, polyaminoamido or polyamino compounds or resins having an amine index between 100 and 800 mg of KOH per g of polyaminoamido or polyamino compound, and salts of these cation-active substances, for example acetates or chlorides.

Useful nonionogenic and amphoteric substances include for example fatty amine carboxyglycinates, amine oxides, fatty alcohol polyglycol ethers, fatty acid polyglycol esters, betaines, such as fatty acid amide N-propylbetaines, phosphoric esters of aliphatic and aromatic alcohols, fatty alcohols or fatty alcohol polyglycol ethers, fatty acid amide ethoxylates, fatty alcohol-alkylene oxide adducts and alkylphenol polyglycol ethers.

To achieve the desired fine state of division, a commercially available, usually coarsely divided epsilon-copper phthalocyanine can be kneaded with a crystalline inorganic salt in the presence of an organic solvent. Such salt kneadings are known to one skilled in the art and are described for example in WO 02/04563 A1.

The finely divided C.I. Pigment Blue 15:6 isolated after kneading is subjected to an aftertreatment to apply the pigment dispersant (II), preferably after filtration as a filter cake or as a dried material.

The present invention also provides a process for producing the pigment preparation of the present invention, which process comprises admixing C.I. Pigment Blue 15:6 with the pigment dispersant of formula (II) before, during or after a kneading, wet-grinding, dry-grinding or finishing operation, if appropriate in the presence of the additive of formula (3), (4) or (5). It is preferable to treat finely divided Pigment Blue 15:6 with the pigment dispersant of formula (II) after a kneading, wet-grinding, dry-grinding or finishing operation.

For example, the dry components can be mixed in granule or powder form before or after grinding; one component can be added to the other in moist or dry form, for example by mixing the components in the form of the moist presscakes. Mixing can also take the form for example of grinding in the dry form, in moist form, for example by kneading, or in suspension, or a combination thereof. Grinding can be carried out in the presence of water, solvents, acids or grinding assistants such as salt.

The moist pigment preparation can be dried using the known drying assemblies, such as drying cabinets, paddle wheel dryers, tumble dryers, contact dryers, belt dryers, spin flash dryers and spray dryers.

The pigment preparations of the present invention can in principle be used for pigmenting all macromolecular organic materials of natural or synthetic origin, for example plastics, resins, coatings, especially metallic coatings, paints, electrophotographic toners and developers, electret materials, color filters and also liquid inks, printing inks.

More particularly, the pigment preparations of the present invention can be used to produce hues in the blue region which are in demand for use in color filters.

There they ensure high contrast and also in other respects meet the requirements for use in color filters, such as high thermal stability or steep and narrow absorption bands.

More particularly, the pigment preparations of the present invention are also useful as colorants in ink-jet inks on an aqueous and nonaqueous basis and also in inks of the hot melt type.

However, the pigment preparations of the present invention are especially useful as colorants for color filters not only for additive color production but also for subtractive color production, as for example in electro-optical systems such as television screens, liquid crystal displays (LCDs), charge coupled devices, plasma displays or electroluminescent displays, which in turn can be active (twisted nematic) or passive (supertwisted nematic) ferroelectric displays or light-emitting diodes, and also as colorants for electronic inks or e-inks or electronic paper (e-paper).

In relation to the production of color filters, not only reflecting but also transparent color filters, pigments in the form of a paste or as pigmented photoresists in suitable binders (acrylates, acrylic esters, polyimides, polyvinyl alcohols, epoxies, polyesters, melamines, gelatin, caseins) are applied to the respective LCD components (for example TFT-LCD=Thin Film Transistor Liquid Crystal Displays or for example ((S) TN-LCD=(Super) Twisted Nematic-LCD). As well as high thermal stability, a high pigment purity is also a prerequisite for a stable paste or pigment photoresist. In addition, the pigmented color filters can also be applied by ink jet printing processes or other suitable printing processes.

The blues of the pigment preparations of the present invention are particularly useful for the color filter color set of red-green-blue (R,G,B). These three colors are present side by side as separate dots of color which, when backlit, produce a full-color picture.

Typical colorants for the blue dot are phthalocyanine colorants or benzimidazolonedioxazine pigments such as for example C.I. Pigment Blue 15:6 and C.I. Pigment Blue 80. The green dot typically utilizes phthalocyanine colorants, for example C.I. Pigment Green 36 and C.I. Pigment Green 7, and customary colorants for the red dot are pyrrolopyrrole, quinacridone and azo pigments, for example C.I. Pigment Red 254, C.I. Pigment Red 209, C.I. Pigment Red 175 and C.I. Pigment Orange 38, individually or mixed.

If necessary, each of the color dots may be admixed with further colors for shading. The red and green hues are preferably admixed with yellow, for example with C.I. Pigment Yellow 138, 139, 150, 151, 180 and 213. The blue hue is preferably admixed with violet, for example with C.I. Pigment Violet 19 or 23.

To determine brilliance and the contrast ratio, a millbase is prepared by dispersing a 15% suspension of the pigment preparation in 66.25% of PGMEA (propylene glycol monomethyl ether acetate) in a paint shaker (Disperse® DAS 200 from Lau GmbH) in the presence of a commercially available macromolecular block copolymer (18.75% Dispersbyk® 161 or 2001 from Byk Chemie) for 5 h. The millbase thus obtained is measured with a Haake RS75 cone and plate viscometer at 20° C. (DIN 53019). Millbase stability is determined by measuring the viscosity after 7 days' storage.

20 g of the millbase thus obtained are dispersed with 30.75 g of a 10% solution of a commercially available acrylate resin (Joncryl® 611 from Jonson Polymers) in a paint shaker (Disperse® DAS 200 from Lau GmbH) for 10 min to obtain a resin base (RB).

To determine contrast ratio and brilliance, the resin base (RB) described is applied by means of a spin coater (POLOS Wafer Spinner) to glass plates (SCHOTT, laser cut, 10×10 cm) and measured for contrast value (TSUBOSAKAELECTRIC CO. LTD, Model CT-1) at a layer thickness of 500 to 1300 nm. The contrast values are standardized to a layer thickness of 1000 nm and compared with one another as relative values (Table 2).

Particle size distribution is determined from a series of electron micrographs. The primary particles are visually identified. The area of each primary particle is determined using a graphical tablet. The diameter of the circle equal in size to the area is determined. The frequency distribution of the equivalent diameters thus computed is determined and the frequencies are converted into volume fractions and represented as particle size distribution. The d₅₀ value indicates the equivalent diameter than which 50% of the particles counted are smaller. The d₉₅ value is defined analogously.

In the examples which follow, percentages and parts are by weight, unless otherwise stated.

### EXAMPLE 1

Production of Finely Divided Epsilon-Copper Phthalocyanine

A 2.5 L laboratory kneader (Werner & Pfleiderer) was charged with 187.5 parts of commercially available epsilon-copper phthalocyanine (d₅₀>100 nm, length/width>5:1), 1125 parts of NaCl (average particle size about 6 μm, determined by laser diffraction) and 308 parts of diethylene glycol. The mixture was kneaded at about 80° C. for 24 h. After kneading, the kneaded material was stirred with 11.25 L of dilute hydrochloric acid (5% by weight) at room temperature for 2 h. After this solvent treatment, the suspension was filtered off and the filter cake was washed with water at 50° C. This gave 676 parts of aqueous filter cake (pigment content 27%). The filter cake was used for producing the pigment preparation of the present invention.

### EXAMPLE 2

1054 parts of epsilon-copper phthalocyanine filter cake from Example 1, corresponding to 268 parts of copper phthalocyanine, were dispersed in 4290 parts of deionized water at 60° C. (pigment content of suspension about 5%). Then, a suspension of 21.4 parts of a copper phthalocyaninesulfonic acid (degree of sulfonation about 1.5) in 400 parts of deionized water/sodium hydroxide at a pH of 10.5±0.5 was added to the pigment suspension. This was followed by stirring at 60° C. for 30 minutes and then by the addition of a solution of 9.4 parts of a cocoamine (Genamin® CC100D, Clariant Produkte (Germany) GmbH) in 250 parts of deionized water and 3 parts of glacial acetic acid. After a further 30 minutes of stirring at 60° C. and adjustment to a pH of 7.0±0.5 with acetic acid, the pigment suspension was filtered and washed with deionized water at 50° C. 288 parts of a pigment preparation (dispersant content: 11.5%) were obtained after drying in a convection oven at 80° C. and pulverizing in a powder mill. The particle size distribution of the finely divided epsilon-copper phthalocyanine pigment preparation was determined by means of transmission electron microscopy (TEM) (see Table 1).

### EXAMPLE 3

949 parts of epsilon-copper phthalocyanine filter cake from Example 1, corresponding to 255 parts of copper phthalocyanine, were dispersed in 3860 parts of deionized water at 60° C. (pigment content of suspension about 5%). Then, a suspension of 15.3 parts of a copper phthalocyaninesulfonic acid (degree of sulfonation about 1.5) in 400 parts of deionized water/sodium hydroxide at a pH of 10.5±0.5 was added to the pigment suspension. This was followed by stirring at 60° C. for 30 minutes and then by the addition of a solution of 6.7 parts of a cocoamine (Genamin® CC100D, Clariant Produkte (Germany) GmbH) in 178 parts of deionized water and 2 parts of glacial acetic acid. After a further 30 minutes of stirring at 60° C. and adjustment to a pH of 7.0±0.5 with acetic acid, the pigment suspension was filtered and washed with deionized water at 50° C. 252 parts of a pigment preparation (dispersant content: 8.6%) were obtained after drying in a convection oven at 80° C. and pulverizing in a powder mill.

### EXAMPLE 4

Example 2 was repeated to produce a pigment preparation from 40 parts of epsilon-copper phthalocyanine as a filter cake, 3.2 parts of copper phthalocyaninesulfonic acid and 0.8 part of 2-ethylhexylamine. 43 parts of a pigment preparation (dispersant content 10%) were obtained after drying and pulverizing.

### EXAMPLE 5

Example 2 was repeated to produce a pigment preparation from 40 parts of epsilon-copper phthalocyanine as a filter cake, 3.2 parts of copper phthalocyaninesulfonic acid and 0.62 part of n-hexylamine. 43 parts of a pigment preparation (dispersant content 9.6%) were obtained after drying and pulverizing.

### EXAMPLE 6

Example 2 was repeated to produce a pigment preparation from 40 parts of epsilon-copper phthalocyanine as a filter cake, 3.2 parts of copper phthalocyaninesulfonic acid and 0.75 part of 2-phenylethylamine. 41 parts of a pigment preparation (dispersant content 9.9%) were obtained after drying and pulverizing.

### EXAMPLE 7

Example 2 was repeated to produce a pigment preparation from 40 parts of epsilon-copper phthalocyanine as a filter cake, 3.2 parts of copper phthalocyaninesulfonic acid and 1.21 parts of dibenzylamine. 40 parts of a pigment preparation (dispersant content 11%) were obtained after drying and pulverizing.

### EXAMPLE 8

Example 2 was repeated to produce a pigment preparation from 40 parts of epsilon-copper phthalocyanine as a filter cake, 3.2 parts of copper phthalocyaninesulfonic acid and 2.17 parts of trioctylamine. 44 parts of a pigment preparation (dispersant content 13.4%) were obtained after drying and pulverizing.

### EXAMPLE 9

Example 2 was repeated to produce a pigment preparation from 40 parts of epsilon-copper phthalocyanine as a filter cake, 3.2 parts of copper phthalocyaninesulfonic acid and 1.77 parts of tribenzylamine. 45 parts of a pigment preparation (dispersant content 12.4%) were obtained after drying and pulverizing.

### EXAMPLE 10

Example 2 was repeated to produce a pigment preparation from 40 parts of epsilon-copper phthalocyanine as a filter cake, 3.2 parts of copper phthalocyaninesulfonic acid and 1.64 parts of oleylamine. 45 parts of a pigment preparation (dispersant content 12.1%) were obtained after drying and pulverizing.

### EXAMPLE 11

Example 2 was repeated to produce a pigment preparation from 40 parts of epsilon-copper phthalocyanine as a filter cake, 3.2 parts of copper phthalocyaninesulfonic acid and 1.8 parts of cocobis(2-hydroxyethyl)amine. 43 parts of a pigment preparation (dispersant content 11%) were obtained after drying and pulverizing.

### EXAMPLE 12

Example 2 was repeated to produce a pigment preparation from 40 parts of epsilon-copper phthalocyanine as a filter cake, 3.2 parts of copper phthalocyaninesulfonic acid and 2.17 parts of triisooctylamine. 45 parts of a pigment preparation (dispersant content 13.4%) were obtained after drying and pulverizing.

### EXAMPLE 13

Example 2 was repeated to produce a pigment preparation from 40 parts of epsilon-copper phthalocyanine as a filter cake, 3.2 parts of copper phthalocyaninesulfonic acid and 1.82 parts of dehydroabietylamine. 44 parts of a pigment preparation (dispersant content 12.5%) were obtained after drying and pulverizing.

### EXAMPLE 14

Example 2 was repeated to produce a pigment preparation from 40 parts of epsilon-copper phthalocyanine as a filter cake, 3.2 parts of copper phthalocyaninesulfonic acid and 0.81 part of 6-aminohexanoic acid. 41 parts of a pigment preparation (dispersant content 10%) were obtained after drying and pulverizing.

### EXAMPLE 15

In a 1 l flask, 24 g of a 9/1 mixture of pulverulent alpha/epsilon-copper phthalocyanine (preground dry in a swing mill, unfinished), 1 g of the additive of the formula

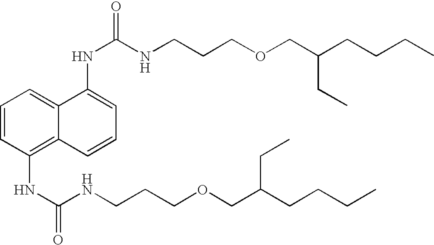

217 g of tetrahydrofuran and 256 g of dilute sulfuric acid (5% by weight) were mixed by stirring until homogeneous. The mixture was subsequently refluxed for 6 h. After this solvent treatment, the suspension was filtered off and the press cake was washed with water at 50° C., dried in a convection oven at 60° C. for 18 h and pulverized using an IKA mill to obtain 22.4 g of a Pigment Blue 15:6 composition, which was further treated as per Example 1 and Example 2.

### COMPARATIVE EXAMPLE 1

### In Accordance with WO 02/48269

148 parts of epsilon-copper phthalocyanine filter cake from Example 1 were dispersed in 710 parts of deionized water at 60° C. (pigment content of suspension about 5%). Then, a suspension of 2.47 parts of a copper phthalocyaninesulfonic acid (degree of sulfonation about 1.5) in 50 parts of deionized water/sodium hydroxide at a pH of 10.5±0.5 was added to the pigment suspension. This was followed by stirring at 60° C. for 30 minutes and then by the addition at pH 7.0-7.5 of a solution of 1.93 parts of trioctylmethylammonium chloride in 40 ml of deionized water to the suspension. After a further 30 minutes of stirring at 60° C., the pigment suspension was filtered and washed with deionized water at 50° C. 44 parts of a pigment preparation (dispersant content: 11%) were obtained after drying in a convection oven at 80° C. (12 h) and pulverizing in a powder mill.

### COMPARATIVE EXAMPLE 2

### In Accordance with WO 02/48268

146 parts of epsilon-copper phthalocyanine filter cake from Example 1 were dispersed in 700 parts of deionized water at 60° C. (pigment content of suspension about 5%). Then, a suspension of 1.8 parts of a copper phthalocyaninesulfonic acid (degree of sulfonation about 1.5) in 36 parts of deionized water/sodium hydroxide at a pH of 10.5±0.5 was added to the pigment suspension. This was followed by stirring at 60° C. for 30 minutes and then by the addition at pH 7.0-7.5 of a solution of 1.4 parts of oleylbis(2-hydroxyethyl)methylammonium chloride in 20 parts of deionized water in 40 ml of deionized water to the suspension. After a further 30 minutes of stirring at 60° C., the pigment suspension was filtered and washed with deionized water at 50° C. 43 parts of a pigment preparation (dispersant content: 8%) were obtained after drying in a convection oven at 80° C. (12 h) and pulverizing in a powder mill.

TABLE 1

| Sample | d₅₀ [nm] | d₉₅/d₅₀ | Length:width |
|---|---|---|---|
| Example 2 | 36 | 1.67 | 1.7:1 |
| Starting material | 120 | 1.62 | 5.1:1 |

TABLE 2

| Sample | Rel. contrast ratio/% |
|---|---|
| Comparative Example 1 | 100 |
| Comparative Example 2 | 98 |
| Example 2 | 108 |
| Example 3 | 105 |
| Example 4 | 108 |
| Example 5 | 110 |
| Example 6 | 112 |
| Example 7 | 107 |
| Example 8 | 108 |
| Example 9 | 108 |
| Example 10 | 110 |
| Example 11 | 104 |
| Example 12 | 109 |
| Example 13 | 107 |
| Example 14 | 106 |
| Example 15 | 108 |

All Examples display the high brilliance needed for color filter applications.

1) A pigment preparation comprising C.I. Pigment Blue 15:6 having a median particle size d₅₀ of 10 to 100 nm and at least one pigment dispersant of the formula (II) 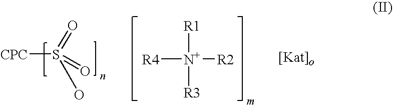
wherein
CPC is a residue of a copper phthalocyanine,
n is from 0.1 to 4,
m is from 0.1 to 4,
Kat is a cation selected from the group consisting of alkali metals and H⁺;
o is from 0 to 3.9, subject to n=m+o;
R¹, R², R³, R⁴ are independently hydrogen or a radical selected from the group consisting of C₁-C₂₀-alkyl, C₂-C₂₀-alkenyl, C₅-C₂₀-cycloalkyl, C₅-C₂₀-cycloalkenyl and C₁-C₄-alkylphenyl, which are each optionally branched and optionally substituted by sulfo, carboxyl, hydroxyl or halogen,
with the proviso that one, two or three of R¹ to R⁴ are hydrogen.

2) The pigment preparation as claimed in claim 1 wherein, in the formula (II), n is 0.2 to 2, m is from 0.2 to 2 and o is from 0 to 1.8, subject to the condition that n=m+o.

3) The pigment preparation as claimed in claim 1
wherein
R¹, R² and R³ are each hydrogen,
R⁴ is a radical selected from the group consisting of C₁-C₂₀-alkyl, C₂-C₂₀-alkenyl, C₅-C₂₀-cycloalkyl, C_{5—}C₂₀-cycloalkenyl and C₁-C₄-alkyl-phenyl, which are each optionally branched and optionally substituted by sulfo, carboxyl, hydroxyl or halogen,
m is from 0.1 to 4,
Kat is a cation selected from the group consisting of H⁺, Li⁺, Na⁺ and K⁺
n is from 0.1 to 4, and
o is from 0 to 3.9.

4) The pigment preparation as claimed in claim 1, wherein R¹, R², R³ and R⁴ are each selected from the group consisting of C₆-C₂₀-alkyl, C₆-C₂₀-alkenyl and benzyl, with the proviso that one, two or three of R¹ to R⁴ are hydrogen.

5) The pigment preparation as claimed in claim 1, wherein the weight ratio of C.I. Pigment Blue 15:6 to pigment dispersant of formula (II) is between 97:3 and 70:30.

6) The pigment preparation as claimed in wherein the primary particles of the base pigment have a length-to-width ratio of less than 3.0:1.

7) The pigment preparation as claimed in claim 1, further comprising an additive, wherein the additive is present in amount between 0.5% to 15% by weight, based on the weight of C.I. Pigment Blue 15:6 and wherein the additive is of formula (3), 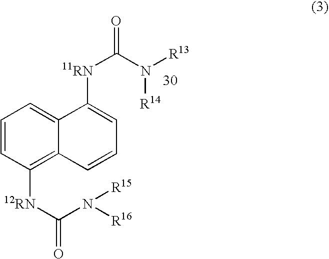
wherein
R¹¹, R¹², R¹³, R¹⁴, R¹⁵ and R¹⁶ are independently hydrogen; C₁-C₂₂ alkyl or C₂-C₂₂ alkenyl whose carbon chain may in each case optionally be interrupted by one or more groupings —O—, —S—, —NR⁹—, —CO— or SO₂— or optionally substituted one or more times by hydroxyl, halogen, aryl, heteroaryl, C₁-C₄ alkoxy and acetyl or both interrupted and substituted; or
C₃-C₈-cycloalkyl whose carbon scaffold may optionally be interrupted by one or more groupings —O—, —S—, —CO— or SO₂— or substituted one or more times by hydroxyl, halogen, aryl, heteroaryl, C₁-C₄-alkoxyl acetyl or a combination thereof; dehydroabietyl, aryl or heteroaryl, or both interrupted and substituted, wherein
R⁹ and R¹⁰ are independently hydrogen or C₁-C₂₂-alkyl, or where R¹³, R¹⁴, R¹⁵ and R¹⁶ are a polyoxyalkylene chain with or without terminal alkylation.

8) A process for producing a pigment preparation as claimed in claim 1, comprising the step of admixing C.I. Pigment Blue 15:6 with the pigment dispersant of formula (II) before, during or after a kneading, wet-grinding, dry-grinding or finishing operation.

9) A pigmented macromolecular organic material of natural or synthetic origin pigmented by a pigment preparation as claimed in claim 1.

10) A composition pigmented by a pigment preparation as claimed in claim 1, wherein the composition is selected from the group consisting of plastics, resins, coatings, paints, electrophotographic toners, electrophotographic developers, liquid inks and printing inks.

11) A pigmented metallic coating, color filter or inkjet ink pigmented by a pigment preparation as claimed in claim 1.
